(19) United States
(12) Patent Application Publication
(10) Pub. No.: US 2015/0352929 A1
(43) Pub. Date: Dec. 10, 2015

(54) VEHICLE DOOR REINFORCEMENT INSERT

(71) Applicants: Hyundai America Technical Center, Inc., Superior Township, MI (US); Hyundai Motor Company, Seoul (KR); Kia Motors Corporation, Seoul (KR)

(72) Inventor: Bavneet S. Brar, Ann Arbor, MI (US)

(21) Appl. No.: 14/297,866

(22) Filed: Jun. 6, 2014

(51) Int. Cl. B60J 5/04

(52) U.S. Cl. CPC B60J 5/0431; B60J 5/0429; B60J 5/0443; B60J 5/0461; B60J 5/0462

(57) ABSTRACT

In one embodiment, a reinforcement insert for a door of a vehicle is provided. The insert includes a door beam for attachment to a door assembly such that the door beam spans a width of the door assembly. The insert also includes a transverse support beam coupled to the door beam that extends substantially parallel to the door beam. The insert further includes a plurality of front support beams coupled to the door beam and transverse support beam that are configured to transfer a frontal impact force into the door beam and transverse support beam. The insert also includes a plurality of rear support beams coupled to the door beam and transverse support beam that are configured to transfer the frontal impact force away from the door beam and transverse support beam.

### BACKGROUND

(a) Technical Field

The present disclosure generally relates to a system for distributing an impact force in a vehicle. In particular, techniques are disclosed whereby impact forces are redirected away from an occupant compartment of the vehicle.

(b) Background Art

Many modern vehicles are equipped with a number of features that redirect and/or absorb impact forces during a crash. For example, some vehicles are designed with a “crumple zone” that absorbs some of the impact forces during a head-on collision. Generally speaking, a crumple zone operates by sacrificing portions of the vehicle to redirect impact forces away from passenger compartment of the vehicle. Thus, on impact, a vehicle may appear to “crumple,” while still maintaining the structural integrity of the passenger compartment.

In addition to employing crumple zones, modern vehicles are also typically equipped with features designed to minimize and/or distribute impact forces on passengers. Passenger restraints such as seatbelts, for example, help to secure a passenger to his or her seat during impact. Airbags may also be deployed during an impact to help cushion a passenger from the impact. In some vehicles, airbags may be located both in the front of the vehicle (i.e., for use during a head-on collision) and along the vehicle's doors (i.e., for use during a side impact to the vehicle).

One area of interest that has emerged in recent years is the study of small overlap frontal collisions. As opposed to a fully head-on collision, small overlap frontal collisions typically involve only a small portion of the front of the vehicle impacting another object. For example, the Insurance Institute for Highway Safety (IIHS) has promulgated a standardized test for small overlap frontal collisions in which only 25% +/−1% of the width of the front of a vehicle impacts a barrier. Such an impact may have significantly different effects on the vehicle than if the vehicle impacted the barrier directly. In other words, measures taken to address other types of impacts (e.g., a full frontal impact, a side impact, etc.) may not fully address small overlap frontal collisions.

In order to solve the problems in the related art, there is a demand for the development of techniques that redirect impact forces in a controlled manner during certain impact conditions, such as during a small overlap frontal collision.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a system for transferring impact forces to the structure of a vehicle, while offering minimal intrusion into the passenger compartment of the vehicle. In particular, techniques are disclosed whereby force paths are incorporated into the packaging space of a vehicle's door to transfer impact forces to the B-pillar of the vehicle, such as those impact forces generated during a small overlap frontal collision.

In one aspect, the present invention provides a reinforcement insert for a door of a vehicle. The insert includes a door beam for attachment to a door assembly such that the door beam spans a width of the door assembly. The insert also includes a transverse support beam coupled to the door beam that extends substantially parallel to the door beam. The insert further includes a plurality of front support beams coupled to the door beam and transverse support beam that are configured to transfer a frontal impact force into the door beam and transverse support beam. The insert also includes a plurality of rear support beams coupled to the door beam and transverse support beam that are configured to transfer the frontal impact force away from the door beam and transverse support beam.

In some aspects, the front and/or rear support beams of the reinforcement insert may form triangular shapes providing different paths through which a frontal impact force may be directed. According to some aspects, the door beam may be a side impact door beam. In one embodiment, the door beam may be coupled to a vertex of a triangle formed by the front support beams. In some embodiments, the insert may also include a plurality of intermediary support beams that couple the transverse support beam to the door beam. The plurality of intermediary support beams and the door hinge may also form a triangle with a vertex of the triangle coupled to the transverse support beam.

In some embodiments, the plurality of front support beams are configured to be coupled to the door assembly at door hinge connection points. The rear support beams may also be configured to transfer the frontal impact force from the door beam and transverse support beam into a B-pillar of the vehicle. In some cases, the plurality of rear support beams may be configured for attachment to the door assembly below a door handle of the door assembly. At least one of the door beam, transverse support beam, front support beams, or rear support beams may also be hollow in construction. The front and rear support beams may further be welded to the door beam, in one embodiment. At least a portion of the reinforcement insert may be constructed using any suitable rigid material, such as steel, composite, or the like.

In a further embodiment, a door assembly is disclosed that includes a window frame and a base portion supporting the window frame. The door assembly also includes a reinforcement insert assembly located within the base portion that includes a door beam that spans a width of the base portion. The reinforcement insert also includes a transverse support beam coupled to the door beam that extends across the base portion and substantially parallel to the door beam. The reinforcement insert further includes a plurality of front support beams coupled to the door beam and transverse support beam that are configured to transfer a frontal impact force into the door beam and transverse support beam. The reinforcement insert additionally includes a plurality of rear support beams coupled to the door beam and transverse support beam that are configured to transfer the frontal impact force away from the door beam and transverse support beam.

In yet another embodiment, a reinforcement insert for a door is disclosed that includes means for transferring a frontal impact force into a door beam spanning a width of the door. The reinforcement insert also includes means for transferring the frontal impact force away from the door beam and into a B-pillar of the vehicle.

Advantageously, the systems and methods described herein allow impact forces to be redirected into the B-pillar of a vehicle, thereby greatly reducing door deformation during a collision and maintaining the integrity of the passenger compartment of the vehicle.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1A is an illustration of a 40% offset frontal impact on a vehicle;

FIG. 1B is an illustration of a full frontal impact on a vehicle;

FIG. 1C is an illustration of a small overlap frontal impact on a vehicle;

FIG. 2 is a diagram illustrating a reinforcement insert for a vehicle door;

FIG. 3 is a diagram illustrating the reinforcement insert of FIG. 2 in greater detail;

FIG. 4 is a diagram illustrating the reinforcement insert of FIG. 3 mounted within a vehicle door;

FIGS. 5A-5C illustrate potential force paths generated during a small overlap frontal impact;

FIGS. 6A-6B illustrate simulated impact test results for a sport utility vehicle (SUV) using a door reinforcement insert; and

FIGS. 7A-7B illustrate simulated impact test results for a small vehicle using a door reinforcement insert.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present disclosure will be described so as to be easily embodied by those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention provides a system for distributing an impact force in a vehicle. In particular, the present invention includes techniques that allow an impact force to a vehicle generated during a small overlap frontal collision to be transferred to the B-pillar of the vehicle.

Particularly, in the present disclosure, in order to fundamentally solve the problem of small overlap frontal collisions, a vehicle door reinforcement insert is disclosed that greatly reduces door deformation during such a collision by transferring the impact force away from the passenger compartment of the vehicle.

According to the present invention, a door reinforcement insert may include a door beam, so as to brace the door against side impacts. The insert may also include a transverse support beam that runs parallel to the door beam. Coupled to the door beam and/or the transverse support beam are a plurality of front and rear support beams. The front support beams transfer the impact force from the front door hinge pillar of the vehicle to the door beam and/or the transverse support beam. The rear support beams transfer the impact force from the door beam and/or the transverse support beam into the B-pillar of the vehicle, thereby reducing the potential deformation of the door and intrusion into the passenger compartment of the vehicle.

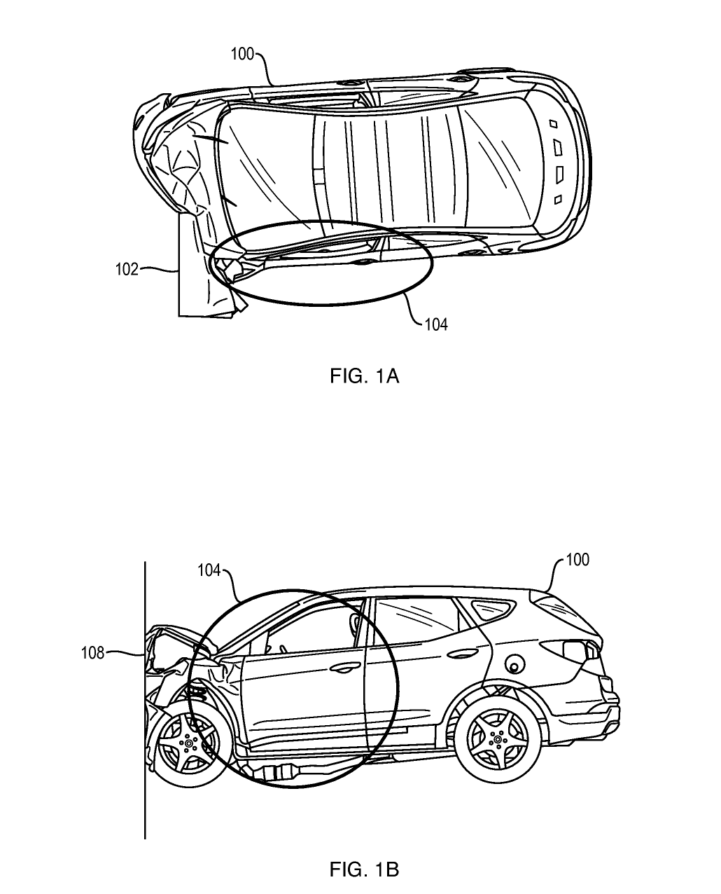

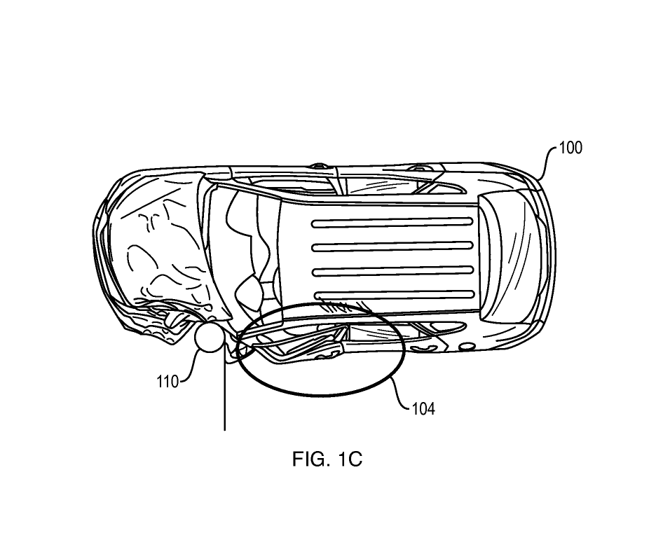

Referring now to FIGS. 1A-1C, various types of vehicle impacts are shown. FIG. 1A illustrates a 40% offset frontal impact to a typical vehicle 100. In this scenario, vehicle 100 impacts an object 102 at approximately 40% of the width of the front of vehicle 100. FIG. 1B illustrates a full frontal impact to vehicle 100. In contrast to the scenario illustrated in FIG. 1A, 100% of the frontal width of vehicle 100 impacts a barrier 108 in the scenario illustrated in FIG. 1B. In both scenarios, vehicle 100 remains relatively unaffected within door region 104. This is due to most modem vehicles being designed to compensate for substantially frontal collisions. In other words, one or both of the front structural rails of vehicle 100 may absorb and distribute the impact force in a 40% offset frontal or full frontal collision, respectively. Thus, the underbody structure of vehicle 100 may be configured to reduce the transferal of the impact force into the passenger compartment of vehicle 100 (e.g., by providing a frontal crumple zone).

In FIG. 1C, a small overlap frontal impact involving vehicle 100 is shown. In this scenario, only a marginal portion of the frontal width of vehicle 100 impacts an object 110. For crash testing purposes, this width is typically 20% +/−1%. However, it is to be appreciated that an actual collision may occur at any percentage of the frontal width of a vehicle. In contrast to the scenarios illustrated in FIGS. 1A-1B, the small overlap frontal impact shown in FIG. 1C demonstrates significant door deformation of vehicle 100 within door region 104. This is because vehicle 100 impacts object 110 in such a way that object 110 misses the front rails of the frame of vehicle 100. Consequently, the impact force generated during the collision with object 110 is transferred into door region 104 and potentially impinging upon the passenger compartment of vehicle 100.

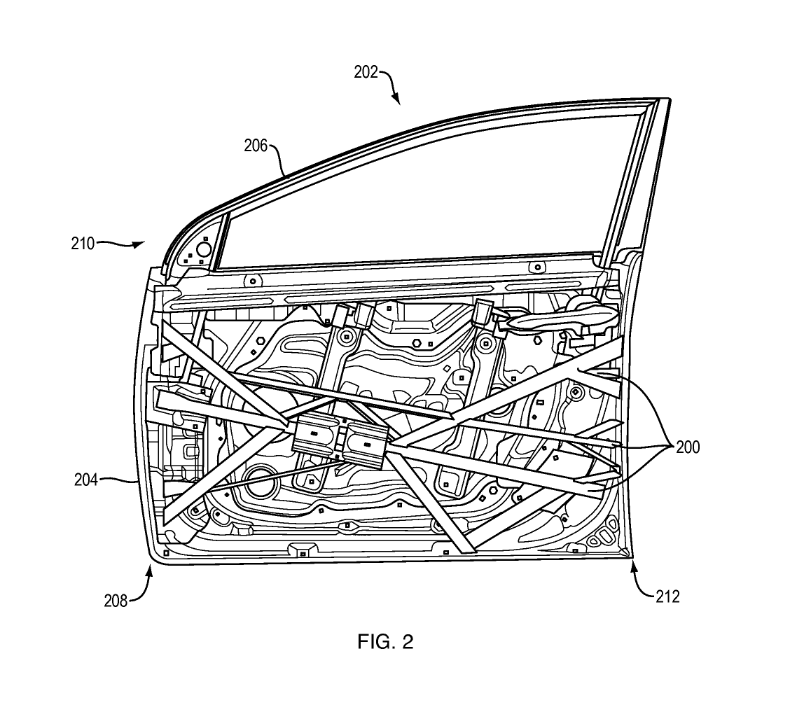

Referring now to FIG. 2, a diagram is shown illustrating a reinforcement insert for a vehicle door, according to various embodiments. As shown, a vehicle door 202 may generally include a window frame 206 supported by a base portion 204. As would be appreciated, base portion 204 may define a hollow interior configured to house various equipment that support the functions of door 202. For example, the interior of base portion 204 may be configured to house the window of door 202 (e.g., when the window of door 202 is down), the mechanisms used to raise or lower the window (e.g., a manual crank, an electric motor, etc.), equipment to support the handle of door 202 (e.g., a door lock, etc.), combinations thereof, and the like.

Door 202 may be mounted to the vehicle and contact several regions along the structure of the vehicle. In one embodiment, bottom portion 204 may include one or more hinges coupled to a hinge column of the vehicle that extends substantially vertically along an axis 208. Window frame 206 may also come into contact with the “A-pillar” of the vehicle located along an axis 210, when door 202 is closed. In general, the A-pillar of a vehicle refers to the structural support that frames vehicle's windshield. Bottom portion 204 may also include a latch or other mechanism configured to couple door 202 to a “B-pillar” of the vehicle that extends substantially vertically along an axis 212. In general, the B-pillar of a vehicle refers to the second most forward support pillar of a vehicle (i.e., behind the A-pillar) that separates the front doors of the vehicle from the second most forward set of doors of the vehicle. When door 202 is in a closed configuration, door 202 may be held in place to the vehicle via the one or more hinges coupled to the hinge pillar and by the latch mechanism coupled to the B-pillar. Conversely, when door 202 is in an open configuration, the latch coupling door 202 to the B-pillar may be released and door 202 may rotate about the hinges coupled to the hinge pillar, thereby allowing door 202 to be rotated radially away from the vehicle.

According to various embodiments, a reinforcement insert 200 may be installed within door 202, to transfer a frontal impact force to the B-pillar of the vehicle. In other words, the resulting impact forces on the A- and hinge pillars of the vehicle are transferred through insert 200 to the B-pillar region of the vehicle. Thus, during a small overlap frontal collision, reinforcement insert 200 may help prevent deformation or buckling of door 202 by increasing the longitudinal impact strength of door 202.

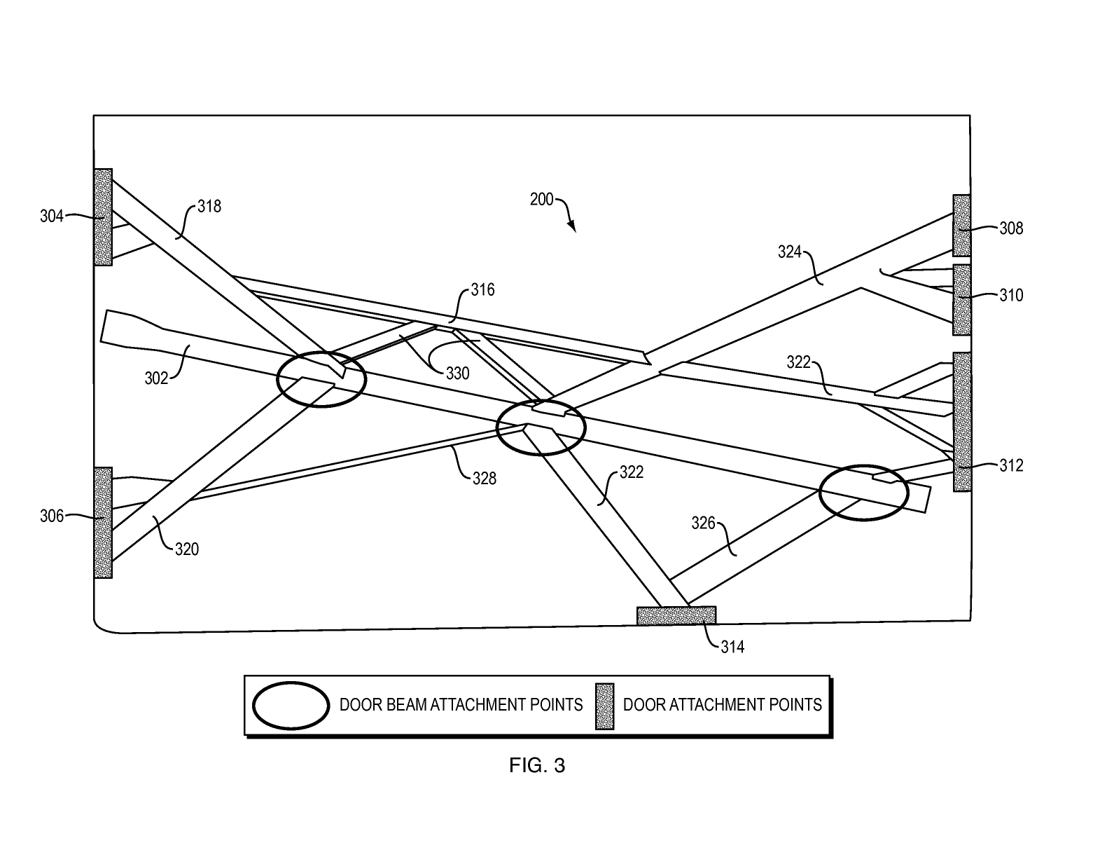

A detailed diagram of reinforcement insert 200 is shown in FIG. 3, according to various embodiments. As shown, reinforcement insert 200 may include a door beam 302 that substantially spans across the width of the door from the fore portion of the vehicle (i.e., from the hinge pillar/A-pillar region of the vehicle) towards the aft portion of the vehicle (i.e., towards the B-pillar region of the vehicle). In some embodiments, door beam 302 is configured to brace the door against side impacts. Thus, in some cases, reinforcement insert 200 may be built upon an existing door member configured to brace the door against side impacts.

Reinforcement insert 200 may include a transverse support beam 316 that extends substantially parallel to door beam 302, in some embodiments. Transverse support beam 316 may extend partially or fully across the width of the door and may be coupled to door beam 302. In one embodiment, transverse support beam 316 is coupled to door beam 302 via a plurality of intermediary support beams 330.

Reinforcement insert 200 may include a plurality of front support beams 318, 320 configured to couple reinforcement insert 200 to the front of the door at front mounting points 304, 306. In one embodiment, front mounting points 304, 306 correspond to door hinge connection points via which the door is mounted to the hinge pillar of the vehicle. In various embodiments, front support beams 318, 320 are configured to transfer a frontal impact force to door beam 302 and/or to transverse support beam 316. For example, during a small overlap frontal collision, the impact forces felt by the vehicle in the hinge column region may be transferred through front support beams 318, 320 into door beam 302 and/or transverse support beam 316 in a direction towards the rear of the vehicle.

Reinforcement insert 200 may also include a plurality of rear support beams 324, 332 that couple reinforcement insert 200 to the rear portion of the door frame at connection points 308-312. In various embodiments, rear support beams 324, 332 are configured to transfer an impact force away from door beam 302 and/or transverse support 316 towards the rear portion of the door and into the B-pillar portion of the vehicle. Thus, during impact, reinforcement insert 200 provides a number of force paths that direct the impact forces towards the rear of the vehicle, thereby maintaining the structural integrity of the door.

Reinforcement insert 200 may, in some cases, include additional attachment points along the top or bottom of the door. For example, as shown, reinforcement insert 200 may include beams 322, 326 that couple door beam 302 of reinforcement insert 200 to a lower attachment point 314. Reinforcement insert 200 may also include additional support members, such as support beam 328 that couples front support beam 320 to door beam 302.

According to various embodiments, reinforcement insert 200 may form any number of triangular shapes, thereby directing and distributing the impact forces within reinforcement insert 200. For example, as shown, front support beams 318, 320 may be coupled to attachment points 304, 306 via triangular shaped connectors, thereby concentrating and directing the impact forces from attachment points 304, 306 into front support beams 318, 320. As shown, door beam 302 may be coupled to front support beams 318, 320 at a vertex of a triangle formed by front support beams 318, 320, in one embodiment. Doing so helps to direct a frontal impact force into door beam 302. In some embodiments, transverse support beam 316 and intermediary support beams 330 may be arranged such that triangular shapes are formed in reinforcement insert 200, thereby distributing and directing the impact forces within the middle portion of reinforcement insert 200. In yet further embodiments, any number of triangular shapes may be formed via rear support beams 324, 332, thereby distributing and directing a frontal impact force towards door attachment points 308-312. Further triangular structures may be formed via beams 322, 326 and door beam 302, via beams 320, 328 and door beam 302, or any other point. Thus, in some embodiments, reinforcement insert 200 may generally form a lattice of triangular shapes that operate to distribute and direct a frontal impact force to the vehicle through the door and towards the rear of the vehicle.

In terms of construction, reinforcement insert 200 may utilize a hollow tube design, in one embodiment. In other words, any or all of the beams of reinforcement insert 200 may be hollow in shape. Dimensionally, certain beams in reinforcement insert 200 may be larger or smaller in diameter than others. For example, front support beam 318 may be larger in diameter than front support beam 320, beam 326 may be larger in diameter than transverse support beam 316, etc. As will be appreciated, the dimensions of the beams within reinforcement insert 200 may be varied to suit a particular vehicle, without departing from the spirit of the teachings herein.

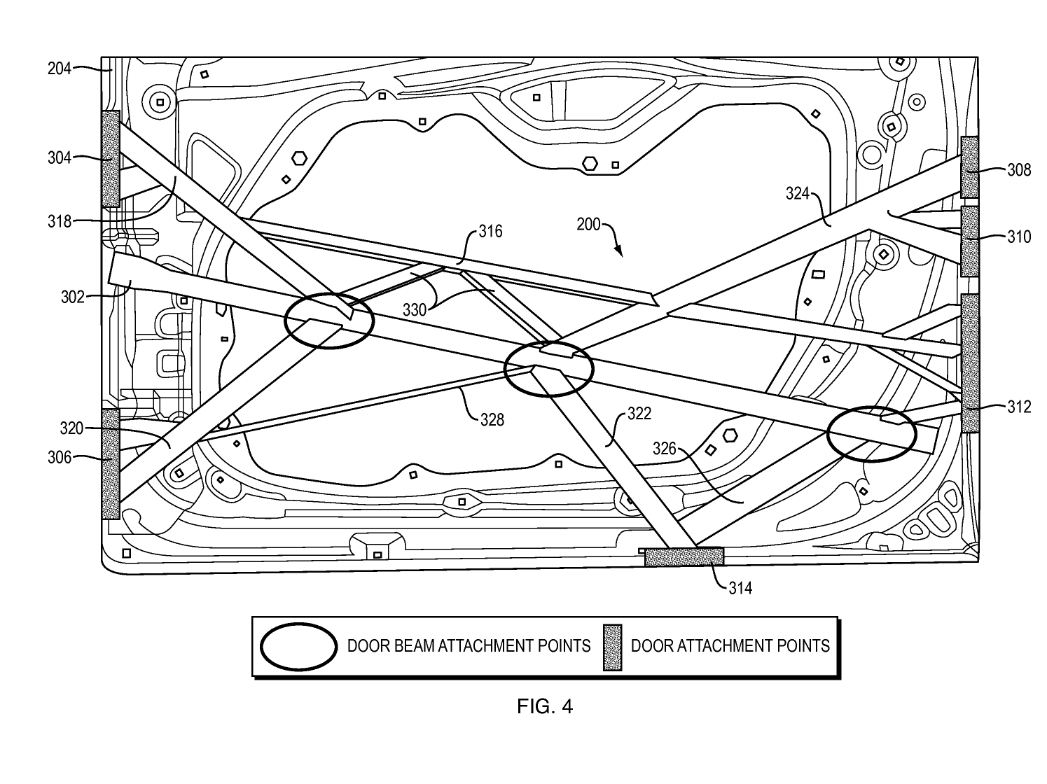

FIG. 4 is a diagram illustrating reinforcement insert 200 mounted within base portion 204 of door 202, according to some embodiments. Advantageously, reinforcement insert 200 may be installed in many existing door designs, with minimal changes to an existing door assembly (e.g., minimal changes would need to be made to retrofit reinforcement insert 200 to an existing door). As shown, reinforcement insert 200 may be mounted within door 202 slightly below the door latch mechanism (not shown) of door 202 at attachment points 304-312. In various embodiments, the beams of reinforcement insert 200 may be coupled together and/or to door 202 via welding or other fastening means (e.g., bolts, brackets, etc.). Reinforcement insert 200 may also be located within door 202 such that the interior of base portion 204 can still accommodate the window of the door, the window's actuator, and any other devices located within the interior of door 202.

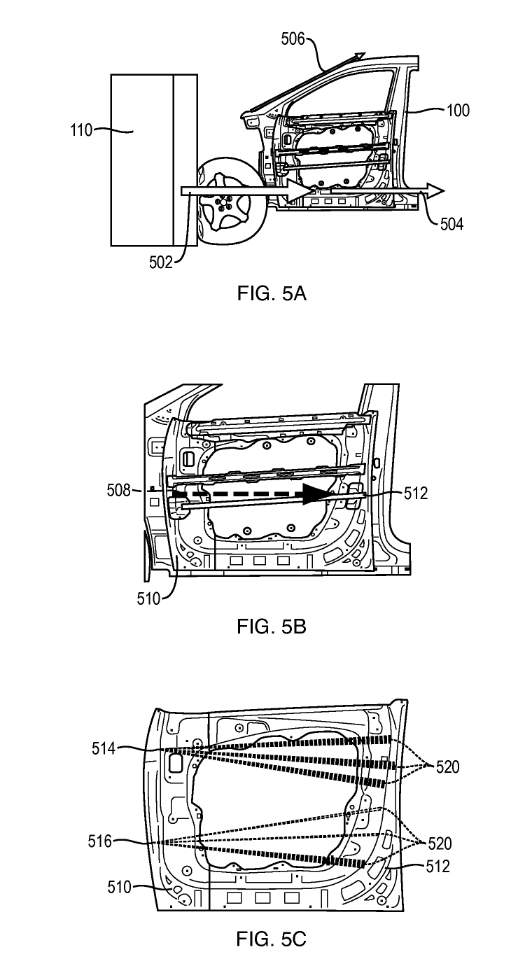

Referring now to FIGS. 5A-5C, illustrations are shown of potential force paths generated during a small overlap frontal impact. FIG. 5A illustrates the forces generated during a small overlap frontal collision, such as the collision depicted in FIG. 1C. During impact with object 110, force 502 is transferred into vehicle 100. In a typical vehicle such as vehicle 100, force 502 may be transferred to the A-pillar of the vehicle (e.g., along path 506) and to the bottom of the door of the vehicle (e.g., along path 504) from the hinge pillar.

According to various embodiments, use of the door reinforcement techniques described herein alters the typical force path of impact force 502. In particular, as shown in FIG. 5B, the majority of the impact force may be transferred along a path 508 from the hinge pillar region 510 of the vehicle and into the B-pillar region 512 of the vehicle along the middle of the door. Thus, the structural integrity of the door is maintained during a frontal impact when the disclosed reinforcement insert is used within the door of the vehicle. In FIG. 5C, an example of the distribution of the impact force via a door reinforcement insert is shown, according to various embodiments. As shown, the impact force may be conveyed from door hinge points 514, 516 generally along paths 518 towards rear contact points 520. In other words, the reinforcement insert may operate to evenly distribute the force loads to the B-pillar region 512 of the vehicle.

Various testing methods have been proposed to evaluate the structural performance of a vehicle during a small offset frontal collision. One such standard of testing is the “Small Overlap Frontal Crashworthiness Evaluation Crash Test Protocol (Version II)” promulgated by the Insurance Institute for Highway Safety (IIHS) in December 2012 in which only 25% +/−1% of the width of a vehicle impacts a barrier during testing. Under the protocol, measurements are taken during the collision at various points along the vehicle to assess the intrusion into the passenger compartment of the vehicle. For example, intrusion measurements under the IIHS protocol may be taken at the steering column, lower left instrument panel, brake pedal, parking brake pedal, left footrest, two rear seat bolts that anchor the seat of the driver to the floor, left toepan, upper dash, lower and upper hinge pillar (e.g., for a total of six points along the hinge pillar/A-pillar of the vehicle), and at points along the rocker panel of the vehicle. The amount of intrusion at each point may then be assessed, to determine whether the vehicle exhibits good structural performance during the test. For example, an intrusion of 0-15 centimeters (cm) at the lower hinge pillar into the passenger compartment may be considered to be “good,” 15-22.5 cm to be “acceptable,” 22.5-30 cm to be “marginal,” and 35+ cm to be “poor.”

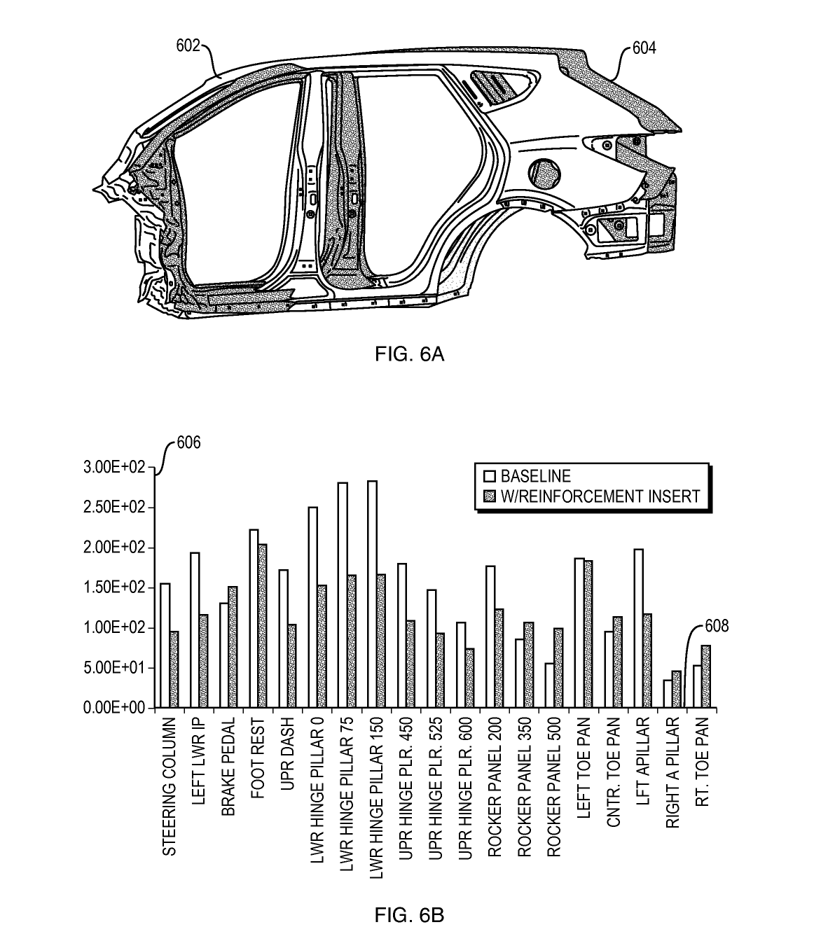

FIGS. 6A-6B illustrate simulated impact test results for a sport utility vehicle (SUV) using a door reinforcement insert. As shown, a baseline simulation was performed on the SUV using only a conventional door (e.g., having only a door beam to protect against side impacts). A second simulation was then performed in which the door reinforcement insert was used, in accordance with the above teachings. In FIG. 6A, simulations are compared between the baseline impact simulation 602 versus the simulation 604 in which the reinforcement insert was used. In FIG. 6B, a bar graph is shown in which intrusion measurements 606 are graphed for each of measurement points 608 from both simulations. For purposes of testing, the measurement points proposed in the Small Overlap Frontal Crashworthiness Evaluation Crash Test Protocol (Version II) by the IIHS were used for measurements 608. As shown, preliminary tests of the door reinforcement insert when used in an SUV demonstrate an improvement over the baseline at a majority of test points. Moreover, the maximal intrusion into the passenger compartment was significantly reduced during the simulation in which the reinforcement insert was used.

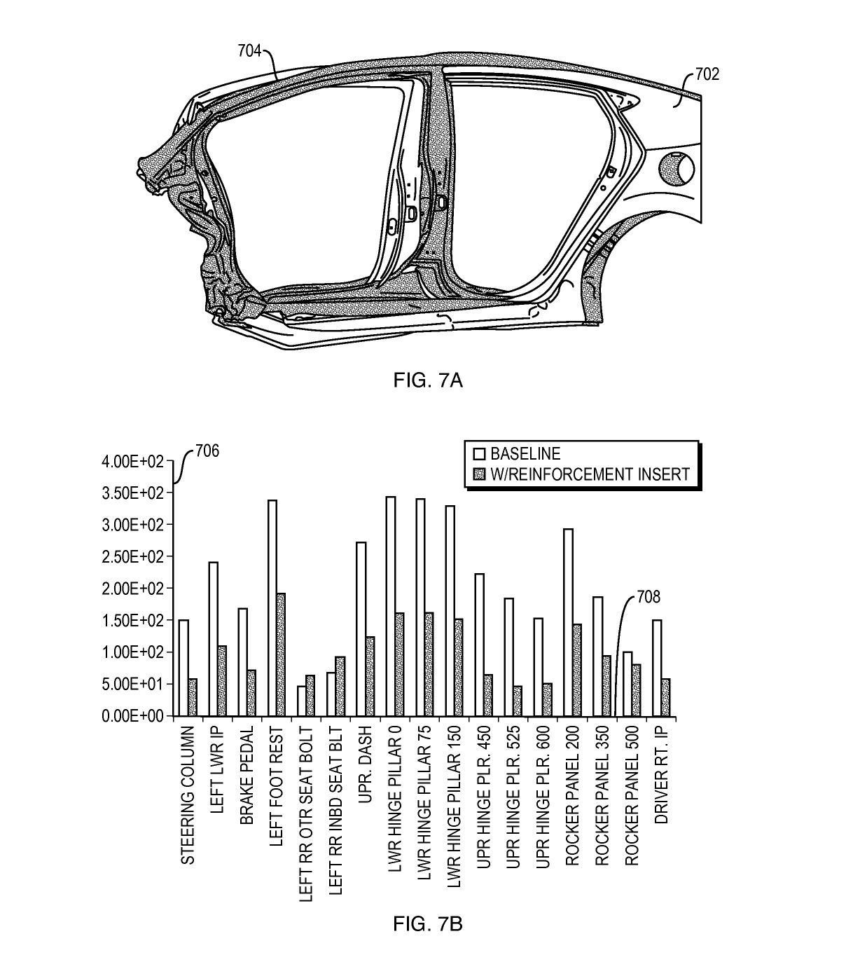

FIGS. 7A-7B illustrate simulated impact test results for a small vehicle using a door reinforcement insert. Similar to the tests performed in FIGS. 6A-6B, a baseline simulation for the small vehicle was compared to a simulation in which a door reinforcement insert was used. In FIG. 7A, baseline simulation 702 is compared to simulation 704 in which the door reinforcement insert was used. Similar to the SUV simulations depicted in FIG. 6A, simulations 702-704 in FIG. 7A also show that a greater amount of the frontal impact force is transferred to the B-pillar of the vehicle when the door reinforcement insert is used. FIG. 7B is a bar chart comparing the intrusion measurements 706 at the IIHS protocol measurement points 708 for each of simulations 702, 704. As shown, simulated test results for a small vehicle demonstrate better performance at nearly every measurement point 708. In addition, the maximum intrusion into the passenger compartment of the vehicle was also significantly reduced when the door reinforcement insert was used.

Accordingly, techniques are described herein that have been shown in simulations to significantly improve the structural integrity of a vehicle during a small overlap frontal collision. In particular, a door reinforcement insert is disclosed herein that transfers a frontal impact force towards the B-pillar of a vehicle, thereby reducing the amount of deformation of the door during impact and also reducing the intrusion into the passenger compartment of the vehicle.

While the embodiment of the present disclosure has been described in detail, the scope of the right of the present disclosure is not limited to the above-described embodiment, and various modifications and improved forms by those skilled in the art who use the basic concept of the present disclosure defined in the appended claims also belong to the scope of the right of the present disclosure.

What is claimed is:

1. A reinforcement insert for a door of a vehicle comprising:
a door beam for attachment to a door assembly such that the door beam spans a width of the door assembly;
a transverse support beam coupled to the door beam that extends substantially parallel to the door beam;
a plurality of front support beams coupled to the door beam and transverse support beam that are configured to transfer a frontal impact force into the door beam and transverse support beam; and
a plurality of rear support beams coupled to the door beam and transverse support beam that are configured to transfer the frontal impact force away from the door beam and transverse support beam.

2. The reinforcement insert of claim 1, wherein the plurality of front support beams comprise a triangular shape.

3. The reinforcement insert of claim 2, wherein the door beam intersects a vertex of the triangular shape.

4. The reinforcement insert of claim 1, wherein the plurality of rear support beams comprise a triangular shape.

5. The reinforcement insert of claim 1, wherein the plurality of front support beams are configured to be coupled to the door assembly at door hinge connection points.

6. The reinforcement insert of claim 1, further comprising:
a plurality of intermediary support beams that couple the transverse support beam to the door beam.

7. The reinforcement insert of claim 6, wherein the plurality of intermediary support beams and the door hinge form a triangle, and wherein a vertex of the triangle is coupled to the transverse support beam.

8. The reinforcement insert of claim 1, wherein the rear support beams are configured to transfer the frontal impact force from the door beam and transverse support beam into a B-pillar of the vehicle.

9. The reinforcement insert of claim 1, wherein at least one of the door beam, transverse support beam, front support beams, or rear support beams is hollow.

10. The reinforcement insert of claim 1, wherein the front and rear support beams are welded to the door beam.

11. The reinforcement insert of claim 10, wherein the door beam is a side impact door beam.

12. The reinforcement insert of claim 1, wherein the plurality of rear support beams are configured for attachment to the door assembly below a door handle of the door assembly.

13. A door assembly comprising:
a window frame;
a base portion supporting the window frame; and
a reinforcement insert assembly located within the base portion comprising:
a door beam that spans a width of the base portion;
a transverse support beam coupled to the door beam that extends across the base portion and substantially parallel to the door beam;
a plurality of front support beams coupled to the door beam and transverse support beam that are configured to transfer a frontal impact force into the door beam and transverse support beam; and
a plurality of rear support beams coupled to the door beam and transverse support beam that are configured to transfer the frontal impact force away from the door beam and transverse support beam.

14. The door assembly of claim 13, wherein the plurality of front support beams comprise a triangular shape.

15. The door assembly of claim 14, wherein the door beam intersects a vertex of the triangular shape.

16. The door assembly of claim 13, wherein the plurality of rear support beams comprise a triangular shape.

17. The door assembly of claim 13, wherein the base portion comprises hinge attachment points configured to couple the base portion to a vehicle, and wherein the plurality of front support beams are configured to be coupled to the door assembly at door hinge connection points.

18. A reinforcement insert for a door comprising:
means for transferring a frontal impact force into a door beam spanning a width of the door; and
means for transferring the frontal impact force away from the door beam and into a B-pillar of the vehicle.

19. The reinforcement insert of claim 18, further comprising:
means for providing parallel support to the door beam.

20. The reinforcement insert of claim 19, further comprising:
means for transferring the frontal impact force into the parallel support means; and
mans for transferring the frontal impact force away from the parallel support means.
